(19) United States
(12) Patent Application Publication
(10) Pub. No.: US 2025/0178206 A1
(43) Pub. Date: Jun. 5, 2025

(54) WORKPIECE RETRIEVAL SYSTEM

(71) Applicant: FANUC CORPORATION, Yamanashi (JP)

(72) Inventor: Takashi YAMAZAKI, Yamanashi (JP)

(73) Assignee: FANUC CORPORATION, Yamanashi (JP)

(21) Appl. No.: 18/844,275

(22) PCT Filed: Jun. 16, 2022
(86) PCT No.: PCT/JP2022/024173

§ 371 Date: Sep. 5, 2024

(51) Int. Cl. B25J 9/16

(52) U.S. Cl. CPC B25J 9/1697; B25J 9/1653

(57) ABSTRACT

A workpiece retrieval system according to one embodiment of the present disclosure, which is capable of reliably retrieving a workpiece, comprises a three-dimensional measurement instrument that measures the shape of a workpiece, a robot having a hand that grips the workpiece, and a control device that controls the robot such that a workpiece is retrieved by the robot on the basis of a result of measurement by the three-dimensional measurement instrument, the control device having: a storage unit that stores a workpiece model, in which the three-dimensional shape of the workpiece is modeled, and a hand model, in which the three-dimensional shape of the hand is modeled; a matching unit that identifies the position and orientation of the workpiece according to a process for matching the result of measurement by the three-dimensional measurement instrument and the workpiece model; a model-positioning unit that positions the workpiece model, within a virtual space, at the position and orientation identified by the matching unit; and a grip determination unit that positions the hand model within the virtual space and, on the basis of the relationship between the hand model and the workpiece model that are positioned within the virtual space, determines a grip position and orientation that apply to the hand when the workpiece is gripped by the hand.

### TECHNICAL FIELD

The present invention relates to a workpiece pick-up system.

### BACKGROUND ART

A robot system is widely used in which surface shape information of a subject such as a distance image and point cloud data is acquired and a position and a posture of a workpiece are identified by a matching process so that the workpiece can be picked up by a robot hand. In some cases, it is necessary to pick up workpieces one by one in order from the workpiece arranged on the upper side among a plurality of workpieces arranged in a randomly overlapping manner. In such a case, the posture of the workpiece may be angled not only in the planar direction but also in the vertical direction. Therefore, there is a possibility that the workpiece cannot be appropriately held by simply approaching the robot hand from directly above.

In such a case, there has been proposed a technique of determining an optimal position and posture for gripping a workpiece with a hand based on workpiece measurement data obtained by three-dimensionally measuring the workpiece with a sensor and hand shape data (for example, see Patent Document 1).

### CITATION LIST

### Patent Document

Patent Document 1: PCT International Publication No. WO2012/066819

### DISCLOSURE OF THE INVENTION

### Problems to be Solved by the Invention

In the case of three-dimensionally measuring a workpiece, in general, only information on the shape of a surface visible from a sensor disposed at a specific position can be obtained. Therefore, when the hand is approached from a direction different from that of the sensor, the hand may not be appropriate for a shape that does not appear in the workpiece measurement data. In addition, since pick-up is performed without sensing which position on the workpiece is gripped, it is necessary to measure the gripping state by some method after the workpiece is picked up when the workpiece direction is required to be aligned in a subsequent process. Therefore, a technique capable of reliably removing the workpiece is desired.

### Means for Solving the Problems

A workpiece pick-up system according to an aspect of the present disclosure includes a three-dimensional measuring instrument configured to measure a shape of a workpiece, a robot including a hand for gripping the workpiece, and a control device configured to control the robot to pick up the workpiece based on a measurement result of the three-dimensional measuring instrument. The control device includes a storing unit configured to store a workpiece model obtained by modeling a three-dimensional shape of the workpiece and a hand model obtained by modeling a three-dimensional shape of the hand, a matching unit configured to identify a position and a posture of the workpiece by performing a matching process between the measurement result of the three-dimensional measuring instrument and the workpiece model, a model positioning unit configured to position the workpiece model in a virtual space in the position and the posture identified by the matching unit, and a grip determining unit configured to position the hand model in the virtual space and determine a gripping position and posture that are a position and a posture of the hand when the hand grips the workpiece, based on a relationship between the hand model and the workpiece model that are positioned in the virtual space.

### Effects of the Invention

According to the present disclosure, it is possible to reliably pick up a workpiece.

### BRIEF DESCRIPTION OF THE DRAWINGS

FIG. 1 is a schematic diagram showing the configuration of a workpiece pick-up system according to a first embodiment of the present disclosure;

FIG. 2 is a schematic diagram showing a simplified measurement result of a three-dimensional measuring instrument of the workpiece pick-up system of FIG. 1;

FIG. 3 is a perspective view of a workpiece model stored by a storing unit of the workpiece pick-up system of FIG. 1;

FIG. 4 is a perspective view showing a hand model stored by the storing unit of the workpiece pick-up system of FIG. 1;

FIG. 5 is a schematic diagram for explaining checking of a gripping position and posture by a grip determining unit of the workpiece pick-up system of FIG. 1; and

FIG. 6 is a schematic diagram for explaining checking of a gripping position and posture different from those of FIG. 5 by the grip determining unit of the workpiece pick-up system of FIG. 1.

### PREFERRED MODE FOR CARRYING OUT THE INVENTION

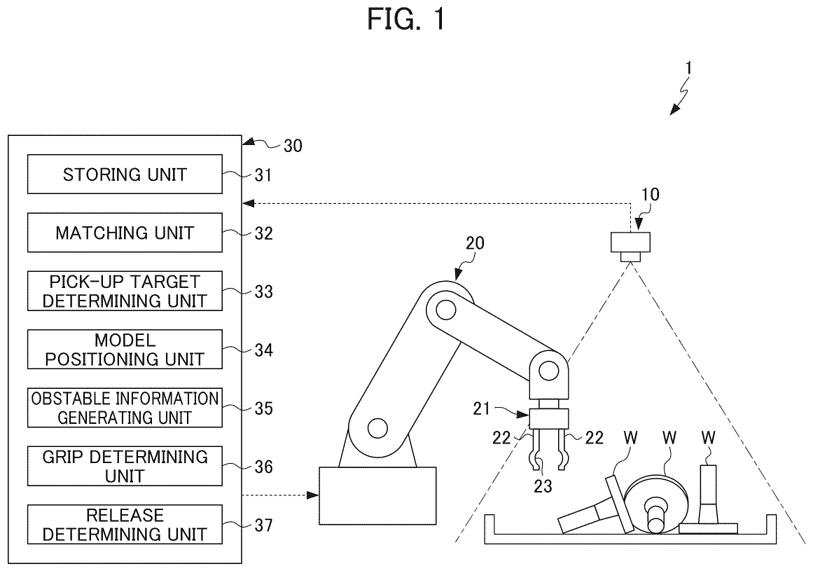

An embodiment of the present disclosure will now be described with reference to the drawings. FIG. 1 is a schematic diagram showing the configuration of a workpiece pick-up system 1 according to a first embodiment of the present disclosure. The workpiece pick-up system 1 picks up one or more workpieces W, which are randomly arranged and can overlap each other, one by one, and positions the picked up workpieces W at a predetermined position and in a predetermined pose.

The workpiece pick-up system 1 includes a three-dimensional measuring instrument 10 configured to measure the shape of the workpiece W, a robot 20 including a hand 21 for gripping the workpiece W, and a control device 30 configured to control the robot 20 to pick up the workpiece W based on the measurement results of the three-dimensional measuring instrument 10.

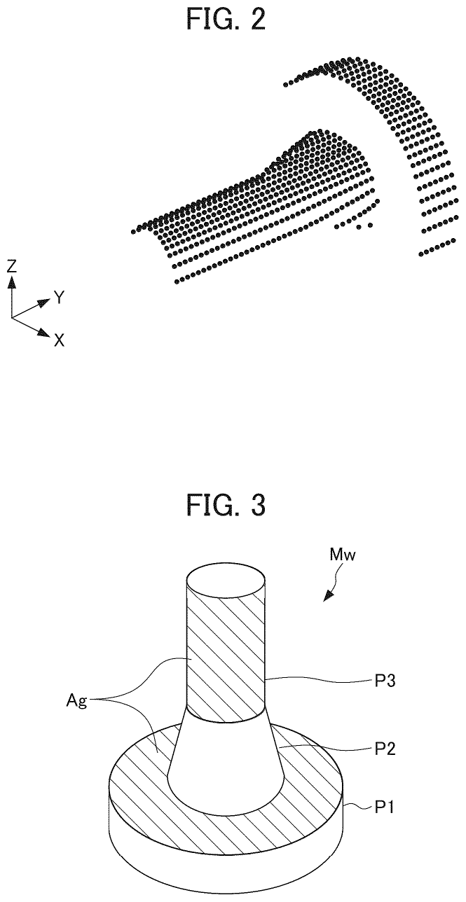

The three-dimensional measuring instrument 10 measures a distance to a measurement target for each two-dimensional position, and outputs measurement results representing a shape of a surface of the measurement target facing the three-dimensional measuring instrument 10, for example, a distance image, point cloud data, and the like. FIG. 2 shows point cloud data of the workpiece W, which is an example of the measurement results output from the three-dimensional measuring instrument 10.

As a specific example of the three-dimensional measuring instrument 10, it is possible to use a stereo camera that includes two two-dimensional cameras each capturing a two-dimensional image of a measurement target and a projector projecting an image including a grid of reference points onto the measurement target, and that calculates the distance from the three-dimensional measuring instrument 10 to each reference point based on the misalignment of the reference points caused by the parallax of the images captured by the two two-dimensional cameras. Alternatively, the three-dimensional measuring instrument 10 may be a device capable of performing other three-dimensional measurements, such as a three-dimensional laser scanner.

The three-dimensional measuring instrument 10 can be fixed, for example, above the area in which the workpieces W are placed such that the entire area in which the workpieces W are placed can be measured. The three-dimensional measuring instrument 10 may be held by the robot 20 and may be positioned at a position that can be measured by the robot 20 each time the shape of the workpiece W is measured.

The robot 20 includes a hand 21 for gripping the workpiece W at its distal end, and determines the position and posture of the hand 21, that is, the coordinate positions of the reference points of the hand 21 and the orientation of the hand 21. As shown in FIG. 1, the robot 20 can be a vertical articulated robot, but is not limited thereto, and may be, for example, an orthogonal coordinate robot, a scalar robot, a parallel link robot, or the like.

The hand 21 can include a pair of gripping fingers 22 for gripping the workpiece W. The gripping fingers 22 may have a shape conforming to the shape of the workpiece W in an area in contact with the workpiece W, for example, a recess 23 in the example shown in the figure.

The control device 30 can be realized by one or more computer devices including, for example, a memory, a processor, an input/output interface, etc., and executing appropriate control programs. The control device 30 includes a storing unit 31, a matching unit 32, a pick-up target determining unit 33, a model positioning unit 34, an obstacle information generating unit 35, a grip determining unit 36, and a release determining unit 37. The components of the control device 30 are ones that fall under categorized functions of the control device 30, and do not need to be clearly distinguishable in terms of physical structure or program structure.

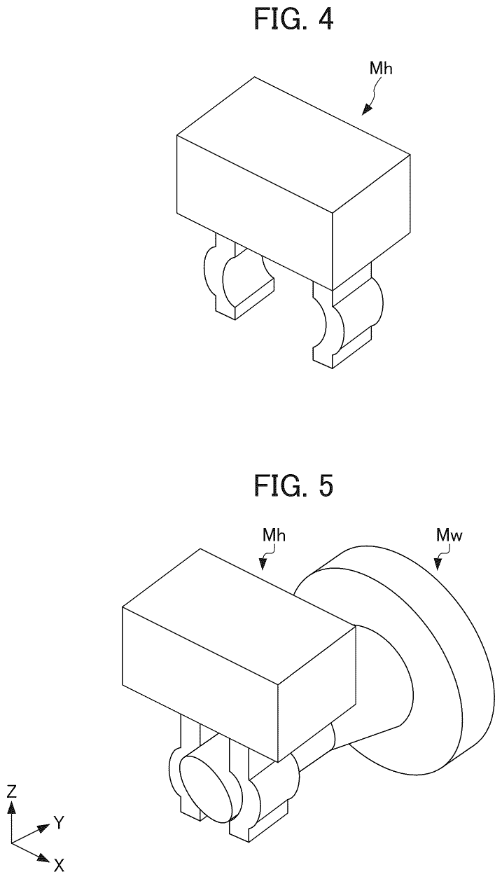

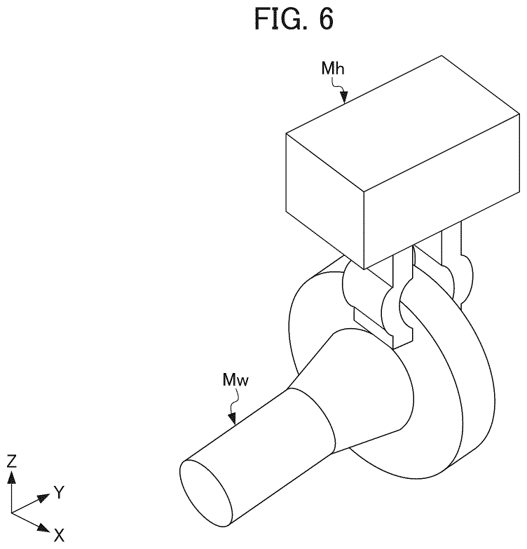

The storing unit 31 stores a workpiece model Mw obtained by modeling the three-dimensional shape of the workpiece W and a hand model Mh obtained by modeling the three-dimensional shape of the hand 21. FIG. 3 shows the workpiece model Mw, and FIG. 4 shows the hand model Mh. The storing unit 31 preferably stores a grippable area Ag set as an area, which can be gripped by the hand 21, in the workpiece model Mw. In FIG. 3, the workpiece model Mw includes a disk-shaped flange portion P1, a truncated cone-shaped intermediate portion P2 connected to one surface of the flange portion P1, and a columnar shaft portion P3 extending from the tip of the intermediate portion P2. For this workpiece model Mw, it is possible to grip the flange portion P1 in the thickness direction or the shaft portion P3 in the radial direction. Therefore, the main surface of the flange portion P1 and the outer peripheral surface of the shaft portion P3, which are hatched in FIG. 3, can be used as the grippable area Ag. In addition, the storing unit 31 may further store an obstacle model that models a three-dimensional shape of an obstacle such as a container in which the workpiece W is housed. Further, the storing unit 31 may store a priority gripping position and posture set as a priority relative position and posture of the hand model Mh with respect to the workpiece model Mw.

The matching unit 32 identifies the position and posture of the workpiece W by performing a matching process between the measurement results of the three-dimensional measuring instrument 10 and the workpiece model Mw stored by the storing unit 31. In addition, when the obstacle model is stored by the storing unit 31, it is preferable that the matching unit 32 also identifies the position and posture of the obstacle by performing a matching process between the measurement results of the three-dimensional measuring instrument 10 and the obstacle model. For the matching process performed by the matching unit 32, well-known methods can be employed. As a specific example, the matching unit 32 can be configured to extract a plurality of feature points from the measurement results of the three-dimensional measuring instrument 10, and determine that the workpiece W is present when the degree of coincidence between the positional relationship between the feature points and the positional relationship between the feature points of the workpiece model Wm is equal to or greater than a predetermined value.

The pick-up target determining unit 33 determines one workpiece W to be picked up by the robot 20 as a pick-up target from among the workpieces W whose positions and poses have been identified by the matching unit 32. It is preferable that the pick-up target determining unit 33 checks the workpiece model Mw positioned in the virtual space by the model positioning unit 34 to be described later, and selects, as the pick-up target, the workpiece W that is less likely to interfere with other workpieces W. As an example, the pick-up target determining unit 33 may determine, as the pick-up target, a workpiece model Mw that has no other workpiece model Mw in contact with its upper side. Alternatively, in a simple manner, the pick-up target determining unit 33 may be configured to set, as the pick-up target, the workpiece located on the uppermost side or closest to preset reference coordinates based on the coordinate positions of the workpieces W identified by the matching unit 32.

The model positioning unit 34 positions the workpiece model Mw in the virtual space in the position and posture identified by the matching unit 32. When the matching unit 32 also identifies the position and posture of the obstacle, the model positioning unit 34 preferably positions the obstacle model in the virtual space in the position and posture identified by the matching unit 32. Since the coordinate system of the virtual space in which the model positioning unit 34 positions the workpiece model Mw and the obstacle model is preferably a coordinate system used for control of the robot 20, the model positioning unit 34 preferably performs a coordinate transformation from the coordinate system of the three-dimensional measuring instrument 10 to the coordinate system of the robot 20.

The obstacle information generating unit 35 generates obstacle information excluding information corresponding to the workpiece model Mw positioned by the model positioning unit 34 or the grippable area Ag of the pick-up target, for example, excluding the corresponding points in the point cloud data from the measurement results of the three-dimensional measuring instrument 10. When an object that cannot be detected by the matching unit 32, for example, an unmodeled foreign object or the like is included, the obstacle information enables such an object to be used as information of an obstacle for which interference with the hand 21 should be avoided.

As schematically shown in FIGS. 4 and 5, the grip determining unit 36 further positions the hand model Mh in the virtual space in which the workpiece model Mw is positioned. The grip determining unit 36 opens and closes the gripping fingers of the hand model Mh, and determines the gripping position and posture that are the position and posture of the hand 21 when the hand 21 grips the workpiece W based on the relationship between the hand model Mh and the workpiece model Mw. Accordingly, it is possible to check whether the workpiece W can be appropriately gripped even in a posture in which the gripping fingers 22 are inserted on the opposite side of the workpiece W from the three-dimensional measuring instrument 10, which cannot be checked from the measurement results of the three-dimensional measuring instrument 10 such as the point cloud data.

In a case where the grip determining unit 36, in determining the possibility of gripping in the priority gripping position and pose, determines that gripping is impossible, the grip determining unit 36 may determine the gripping position and posture by determining the possibility of gripping in a position and a posture modified from the priority gripping position and posture based on a predetermined rule. Thus, by using the priority gripping position and posture as the starting point to search for the gripping position and pose, the computational load can be suppressed.

It is preferable that the grip determining unit 36 determines the gripping position and posture such that the hand model Mh does not interfere with the workpiece models Mw of the workpieces W other than the pick-up target. By avoiding interference with the workpiece models Mw of the workpieces W other than the pick-up target, when actually removing the workpiece W with the hand 21, it is possible to prevent a situation in which the position and posture of the workpiece W as the pick-up target changes due to the hand 21 moving a workpiece W other than the pick-up target, making it impossible for the hand 21 to properly grip the workpiece W.

Specifically, the grip determining unit 36 can be configured to determine the gripping position and posture based on the size of the contact area between the workpiece model Mw and the hand model Mh, and for example, set a position and posture in which the contact area is equal to or greater than a threshold as the gripping position and pose. The contact area can be calculated, for example, as an area of a region in which the distance from the surface of the workpiece model Mw to the hand model Mh is equal to or less than a predetermined threshold in a state in which the interval between the gripping fingers 22 of the hand model Mh is reduced and the gripping fingers 22 initially contact the workpiece model Mw. In this manner, by using the contact area between the workpiece model Mw and the hand model Mh as an index, it is possible to determine a gripping position and posture that enables appropriate gripping regardless of the posture of the workpiece W without performing a complicated preparation operation such as teaching a plurality of relative positions and poses of the hand 21 with respect to the workpiece W in advance.

When the storing unit 31 stores the grippable area Ag, the grip determining unit 36 may determine the gripping position and posture based on the relationship between the grippable area Ag of the workpiece model Mw and the hand model Mh. That is, the grip determining unit 36 does not need to check the relationship between the hand model Mh and the area other than the grippable area Ag of the workpiece model Mw. As a result, the computational load can be reduced, and the threshold or the like of the contact area for determining the gripping position and posture can be set as a stricter condition. In this case, the grip determining unit 36 preferably determines the gripping position and posture such that the hand model Mh does not interfere with the area other than the grippable area Ag of the workpiece model Mw, instead of ignoring the area other than the grippable area Ag of the workpiece model Mw.

Further, the grip determining unit 36 preferably determines the gripping position and posture such that the shape indicated by the obstacle information generated by the obstacle information generating unit 35 and the hand model Mh do not interfere with each other. This allows the workpiece W to be picked up while avoiding unmodeled foreign objects.

The release determining unit 37 determines a release position and pose, which are the position and posture of the hand 21 when releasing the picked up workpiece W, based on the gripping position and posture determined by the grip determining unit 36. Accordingly, since the workpiece W can be released in a constant position and pose, the workpiece pick-up system 1 can be used as a supply device or an assembly device for the workpiece W.

The workpiece pick-up system 1 identifies the position and posture of the workpiece W by performing a matching process between the measurement results of the three-dimensional measuring instrument 10 and the workpiece model Mw, positions the workpiece model Mw and the hand model Mh in the virtual space, and simulates the relationship between the workpiece W and the hand 21, thereby determining the gripping position and posture in consideration of the shape that does not appear in the measurement results of the three-dimensional measuring instrument 10, so that the workpiece can be picked up reliably. In addition, since the workpiece pick-up system 1 determines the relative positions and angles of the workpiece model Mw and the hand model Mh with respect to each other by simulation, it is not necessary to teach in advance which position of the workpiece W is gripped by the hand 21 at what relative angle.

Although the embodiment of the present disclosure has been described above, the present disclosure is not limited to the above-described embodiment. In addition, the effects described in the above-described embodiment are merely listed as advantageous effects generated from the present invention, and the effects of the present invention are not limited to those described in the above-described embodiment.

As an example, in the workpiece pick-up system according to the present invention, the obstacle information generating unit may be omitted. When the posture of the workpiece at the time of release is freely selected, the release determining unit may be omitted. The pick-up target determining unit may be configured to identify the workpiece as the pick-up target in accordance with input by a user, or it may be omitted if there is always only one workpiece.

### EXPLANATION OF REFERENCE NUMERALS

1 workpiece pick-up system
10 three-dimensional measuring instrument
21 hand
20 robot
22 gripping finger
23 recess
30 control device
31 storing unit
32 matching unit
33 pick-up target determining unit
34 model positioning unit
35 obstacle information generating unit
36 grip determining unit
37 release determining unit
Ag grippable area
Mw workpiece model
Mh hand model
W workpiece

1. A workpiece pick-up system comprising:
a three-dimensional measuring instrument configured to measure a shape of a workpiece;
a robot including a hand for gripping the workpiece; and
a control device configured to control the robot to pick up the workpiece based on a measurement result of the three-dimensional measuring instrument,
the control device comprising:
a storing unit configured to store a workpiece model obtained by modeling a three-dimensional shape of the workpiece and a hand model obtained by modeling a three-dimensional shape of the hand;
a matching unit configured to identify a position and a posture of the workpiece by performing a matching process between the measurement result of the three-dimensional measuring instrument and the workpiece model;
a model positioning unit configured to position the workpiece model in a virtual space in the position and the posture identified by the matching unit; and
a grip determining unit configured to position the hand model in the virtual space and determine a gripping position and posture that are a position and a posture of the hand when the hand grips the workpiece, based on a relationship between the hand model and the workpiece model that are positioned in the virtual space.

2. The workpiece pick-up system according to claim 1, wherein
the storing unit stores a grippable area that can be gripped in the workpiece model, and
the grip determining unit determines the gripping position and posture based on a relationship between the grippable area in the workpiece model and the hand model.

3. The workpiece pick-up system according to claim 1, wherein
the storing unit stores a priority gripping position and posture set as a prioritized relative position and posture of the hand model with respect to the workpiece model, and
in a case where the grip determining unit, in determining possibility of gripping in the priority gripping position and pose, determines that gripping is impossible, the grip determining unit determines possibility of gripping in a position and a posture modified from the priority gripping position and posture based on a predetermined rule.

4. The workpiece pick-up system according to claim 2, wherein
the control device further comprises an obstacle information generating unit configured to generate obstacle information excluding information corresponding to the grippable area from the measurement result of the three-dimensional measuring instrument, and
the grip determining unit determines the gripping position and posture such that the hand model does not interfere with a shape indicated by the obstacle information.

5. The workpiece pick-up system according to claim 1, wherein
the model positioning unit positions the workpiece model of the workpiece as a pick-up target and a workpiece model of a workpiece other than the pick-up target in the virtual space, and
the grip determining unit determines the gripping position and posture such that the hand model does not interfere with the workpiece model of the workpiece other than the pick-up target.

6. The workpiece pick-up system according to claim 1, wherein
the control device further comprises an obstacle information generating unit configured to generate obstacle information excluding information corresponding to the workpiece model positioned by the model positioning unit from the measurement result of the three-dimensional measuring instrument, and
the grip determining unit determines the gripping position and posture such that the hand model does not interfere with a shape indicated by the obstacle information.

7. The workpiece pick-up system according to claim 1, wherein the control device further comprises a release determining unit configured to determine a release position and posture that are a position and a posture of the hand when the hand releases the workpiece picked up, based on the gripping position and posture determined by the grip determining unit.

8. The workpiece pick-up system according to claim 1, wherein the grip determining unit determines the gripping position and posture based on a size of a contact area between the workpiece model and the hand model.
